(19) United States
(12) Patent Application Publication
(10) Pub. No.: US 2015/0213684 A1
(43) Pub. Date: Jul. 30, 2015

(54) System and Method to Increase Handle in Pari-Mutuel Betting Environments

(71) Applicant: TSG Developments Investments, Inc., Aurora (CA)

(72) Inventors: Scott Daruty, Newport Beach, CA (US); Michael Calderone, Cooper City, FL (US)

(73) Assignee: TSG Developments Investments, Inc., Aurora (CA)

(21) Appl. No.: 14/164,029

(22) Filed: Jan. 24, 2014

(51) Int. Cl. G07F 17/32

(52) U.S. Cl. CPC G07F 17/3258

(57) ABSTRACT

Methods, systems, and apparatus, including medium-encoded computer program products, for pari-mutuel wagering are disclosed. In one aspect, a method of supporting a wager type for a pari-mutuel betting race having a predetermined number of participants includes: receiving odds data for each of the predetermined number of participants in the race; removing, from the predetermined number of participants, one or more favorites to win the race based on the odds data, thereby forming a reduced field of participants for consideration in the race; and providing the reduced field of participants to a totalizer system for use in calculating a pari-mutuel payout for a wager of the wager type based on the reduced field of participants and an outcome of the race once run with the one or more favorites, while ignoring the one or more favorites for purposes of the wager type.

### BACKGROUND

This specification relates to pari-mutuel wagering, such as is used in horse and dog racing.

Pari-mutuel wagering is a betting system in which the bets of a specific type are placed together in a pool. The “house-take” or “vig” (a percentage taken out for the management of the wagering activity) and any taxes are removed from the pool before payouts are made, and payoffs are calculated by sharing the pool among all winning bets. Some countries refer to pari-mutuel wagering as the “Tote” after the totalisator, which calculates and displays payouts for bets already made.

Pari-mutuel wagering can use many different types of bets. For example, in the horse racing context, bet types include Win, Place, Show, Exacta, Trifecta, and Superfecta. In addition, some bet types span multiple races. For example, US Pat. Pub. No. 2007/0197281 describes a wager that spans four races, and US Pat. Pub. No. 2008/0248846 describes a lottery game type pari-mutuel wager that spans multiple races.

### SUMMARY

This specification describes technologies relating to pari-mutuel wagering, such as is used in horse and dog racing. In general, one or more aspects of the subject matter described in this specification can be embodied in a method of supporting a wager type for a pari-mutuel betting race having a predetermined number of participants, the method including: receiving odds data for each of the predetermined number of participants in the race; removing, from the predetermined number of participants, one or more favorites to win the race based on the odds data, thereby forming a reduced field of participants for consideration in the race; and providing the reduced field of participants to a totalizer system for use in calculating a pari-mutuel payout for a wager of the wager type based on the reduced field of participants and an outcome of the race once run with the one or more favorites, while ignoring the one or more favorites for purposes of the wager type. Other embodiments of this aspect include corresponding systems, apparatus, and computer program products.

The race can include two or more pari-mutuel betting races, the receiving can include receiving participant odds data for each of the races, the removing can include removing one or more favorites from each of the races to form a reduced field from each of the races, and the providing can include providing the reduced fields for the races to the totalizer system for use in calculating the pari-mutuel payout for the wager of the wager type, wherein the wager type includes a selection for each of the races. The method can further include identifying evenly matched participants in each of the races to form the respective reduced fields for the races.

The selection for each of the races can include a finishing order of participants from the reduced field. The selection for each of the races can include a finishing order of all participants from the reduced field. Moreover, the reduced field for each of the races can have four participants total.

According to another aspect, a system can include: a database system configured to store wager information for pari-mutuel betting on races, including a reduced field bet; and a totalizer system coupled with the database system to access the wager information and configured to perform pari-mutuel payout calculations for at least one of the races, and the totalizer system configured to perform additional pari-mutuel payout calculations for the same at least one of the races while treating one or more race participants as non-existent in accordance with the reduced field. The system can also include a computer programmed to identify evenly matched participants in each of the races to form the reduced field bet.

The reduced field bet can include a finishing order of participants from the reduced field. The reduced field bet can include a finishing order of all participants from the reduced field. In addition, the reduced field for each of the races can have four participants total.

According to another aspect, a computer-implemented method can include: receiving multiple bets at a computer system, each of the bets being one of at least two types, the bet types including a first bet type corresponding to a single race, and a second bet type corresponding to two or more races, which include the single race, wherein each of the bets include a bet amount and a wagered outcome, wherein the wagered outcome for a bet of the first bet type include a win, place or show for a specific participant in the single race, and wherein the wagered outcome for a bet of the second bet type includes (i) a specific ordering of three or more participants in the single race, excluding at least the specific participant of the bet of the first bet type from consideration, and (ii) a specific ordering of three or more participants in each remaining race of the two or more races, excluding at least one participant from consideration in each remaining race of the two or more races; combining, at the computer system, bet amounts to form a betting pool; determining, at the computer system, a payout for the bet of the first bet type after the single race is run; and determining, at the computer system, a payout for the bet of the second bet type, in part by ignoring the excluded participants, after the two or more races are run.

The excluded participants can be unevenly matched compared with other participants in the races. In addition, the specific ordering of three or more participants in the single race can be a specific ordering of exactly four participants in the single race, and the specific ordering of three or more participants in each remaining race of the two or more races can be a specific ordering of exactly four participants in each remaining race of the two or more races.

Particular embodiments of the subject matter described in this specification can be implemented to realize one or more of the following advantages. Races with small betting fields can be enhanced to increase handle (e.g., including additional revenue for the horsemen in a horse race). For example, a horse race with one or two stand-out horses, which might not normally attract many bettors, can have a new type of pari-mutuel wager created for the race that attracts new interest. A pari-mutuel wager on a field inside a field can reduce the problems that race tracks can have when running short fields and obvious favorites, which can result in lower betting handle. The field inside a field concept can also be used to fulfill multi-race bets. By changing the dynamics of the fields and eliminating the stand-out contenders in a multi-bet race, betting pools can be increased substantially (e.g., 20% or more). Tying this into a multi-race exotic bet can increase the handle at the track without cannibalizing individual betting pools, and the new bet type can attract interest of both novice bettors and sophisticated handicappers. In addition, the new bet type can be of particular value to smaller tracks for increasing wagering dollars.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system for pari-mutuel wagering.

FIG. 2 shows an example of a method of creating and handling a pari-mutuel wager.

FIGS. 3A & 3B show another example of a method of creating and handling a pari-mutuel wager.

FIGS. 4A & 4B show an example of creating a pari-mutuel wager structure.

Like reference numbers and designations in the various drawings indicate like elements.

### DETAILED DESCRIPTION

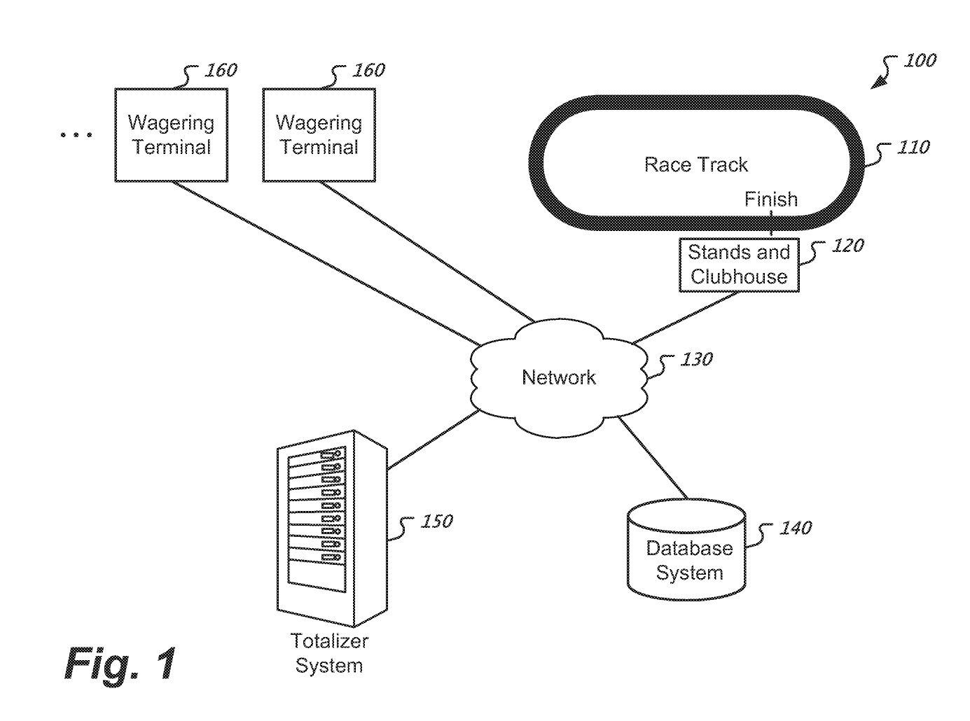

FIG. 1 shows an example of a system 100 for pari-mutuel wagering. A race track 110 (e.g., for horse racing) has an associated finish line and on-site facility 120 (e.g., stands and a club house) where bets can be placed and races observed. The system 100 can include a network 130 connecting a database system 140 and a totalizer system 150 with wagering terminals 160. The network 130 can be a private local area network, a public network (e.g., the Internet) over which a virtual private network (VPN) is run, or a combination of these.

The database system 140 can store wager information received through the wagering terminals 160. The stored wager information is for pari-mutuel betting on races at the track 110, including a reduced field bet, as described further below. The totalizer system 150 can access the wager information in the database system 140 and can perform pari-mutuel payout calculations for the races at the track 110. In addition, the database system 140 can receive and store wager information for races at other tracks, which can be in other cities, and the totalizer system 150 can perform pari-mutuel payout calculations for races across multiple tracks.

FIG. 1 shows the network 130, the database system 140, the totalizer system 150, and the wagering terminals 160 as being separate from the track facility 120. However, in some implementations, these components are all integrated into the track facility 120. In other implementations, one or more of these components are remote from the track facility 120. For example, the wagering terminals 160 can include terminals at the track 110, terminals at one or more other tracks, terminals at off-site betting locations (e.g., Las Vegas casinos), applications running on networked devices (e.g., mobile phones), or a combination of these, and the database system 140 and the totalizer system 150 can be located remotely at a server farm.

The totalizer system 150 can perform traditional pari-mutuel payout calculations plus additional pari-mutuel payout calculations for at least one of the races by treating one or more race participants as non-existent in accordance with a reduced field. For example, in a field of seven where two horses represent approximately 50% of the entire win pool, eliminating those two horses from consideration in a wager type (which is offered in addition to the traditional wager types available for all the horses in the race) creates a much more evenly matched field for racing fans to bet. A more even field creates a greater chance for larger payouts, encouraging more individuals to wager. Thus, races that might otherwise be skipped by bettors (because they have minimal value) are made more attractive to wagering because the dynamics of the odds have been changed.

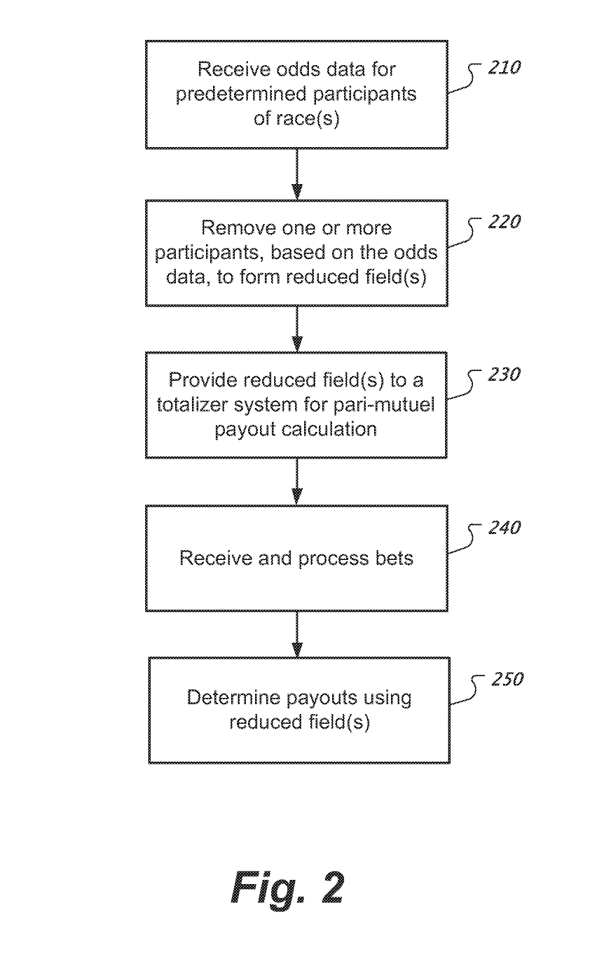

FIG. 2 shows an example of a method of creating and handling a pari-mutuel wager. At 210, odds data is received for the predetermined participants of one or more races. In some cases, the odds data can originate well before a race, such as odds data generated by odds makers. In some cases, the odds data can be created and/or updated based on bets received for a race. In some implementations, the odds data is for a set of races that are to be considered together. This can be all the races to be run on a particular track in a single day. Alternatively, this can be races to be run on different tracks on a single day. In some implementations, the races can span more than one day.

At 220, one or more participants are removed from each of the one or more races, based on the odds data, to form a reduced field for each of the one or more races. For example, one or more favorites to win each race can be removed from consideration for purposes of creating a different bet type. This can make the remaining field more competitive and more interesting to professional handicappers. In some implementations, long shot participants (with very low chances of winning) can also be removed to help generate a close match up among the remaining field.

At 230, the one or more reduced fields are provided to a totalizer system for pari-mutuel payout calculations, which can occur both before and after the race(s). These calculations will be based on the reduced field for each race, i.e., ignoring the removed participants for that race. For example, the totalizer system can identify the proper subset of the race participants as their own field of racers, as if the other race participants do not exist.

At 240, bets of the created bet type are received and processed. Each bet includes a bet amount and a wagered outcome. The bet amount can have a minimum and is combined into a betting pool. The minimum bet amount can be $0.10 or $0.25, depending on the number of races to which the bet is tied. The wagered outcome indicates the race result upon which the bettor wins the bet. The wagered outcome can be a traditional type of wagered outcome, such as win, place or show, within the reduced field. In some implementations, the wagered outcome is a different type of bet, which can span multiple races.

For example, the wagered outcome can be a specific ordering of three or more participants in a race, and the wagered outcome can also include a specific ordering of three or more participants in each of one or more additional races. Thus, in a horse race example, all that matters for winning a given bet is the finishing order of the horses selected by the bettor for a given race, irrespective of how the removed horse(s) and the non-bet horse(s) perform in that race. Thus, the bet is not about the selected participants winning a race, but about the selected participants beating each other in the order selected by the bettor. Also note that the number of racers selected by the bettor in a particular race can be less than the number of racers in the reduced field generated by the system for that race.

At 250, payouts are determined using the one or more reduced fields after the one or more races are run. Note that when more than one race is used, the payouts can be increased significantly, which can attract greater interest from novice bettors and thus also increase the betting pool. For example, in the case of each wagered outcome being the selection of four horses to finish in a specified order, the mathematical payouts based on the number of races included in the wagered outcome are generally as follows:

2 Races=576;

3 Races=13,281;

4 Races=331,776;

5 Races=7,962,624; and

6 Races=191,102,976.

Note that because the horses from which the bettor selects an ordering of horses at the finish are evenly matched, the above odds should hold fairly true. In addition, because the bet is not about the selected participants finishing the race in a particular position, but rather about the selected participants finishing the race in a particular order relative to each other, the betting value of the race can be dynamically changed form a handicapper's perspective.

Thus, the amount wagered on races can be increased by making them more attractive to the true racing fan. Races that would normally be avoided by astute handicappers (short fields and stand-out plays) can be made more interesting and valuable to those handicappers. By identifying the most evenly matched race participants (e.g., horses) a fair playing field can be created for both the sophisticated handicapper and the novice bettor (e.g., the lottery game type player). Thus, main street (e.g., lottery players) and horse players can be merged together in the same wager, which can further increase the betting pools and make the bet even more attractive.

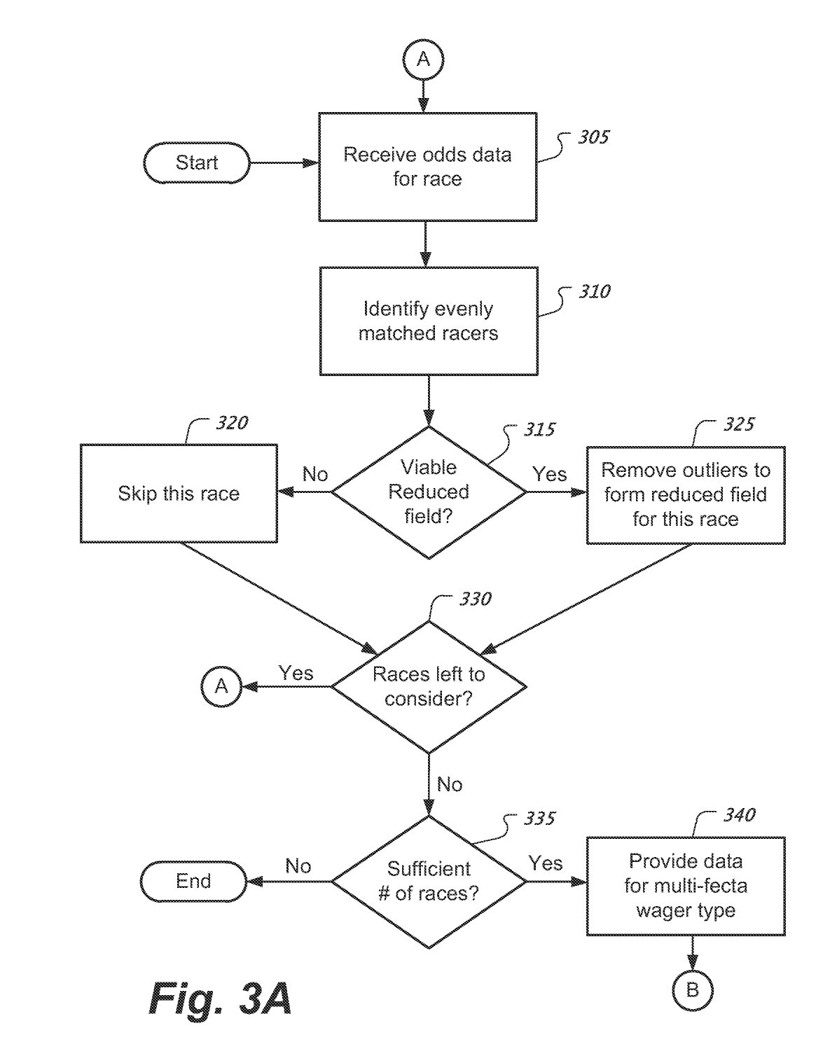

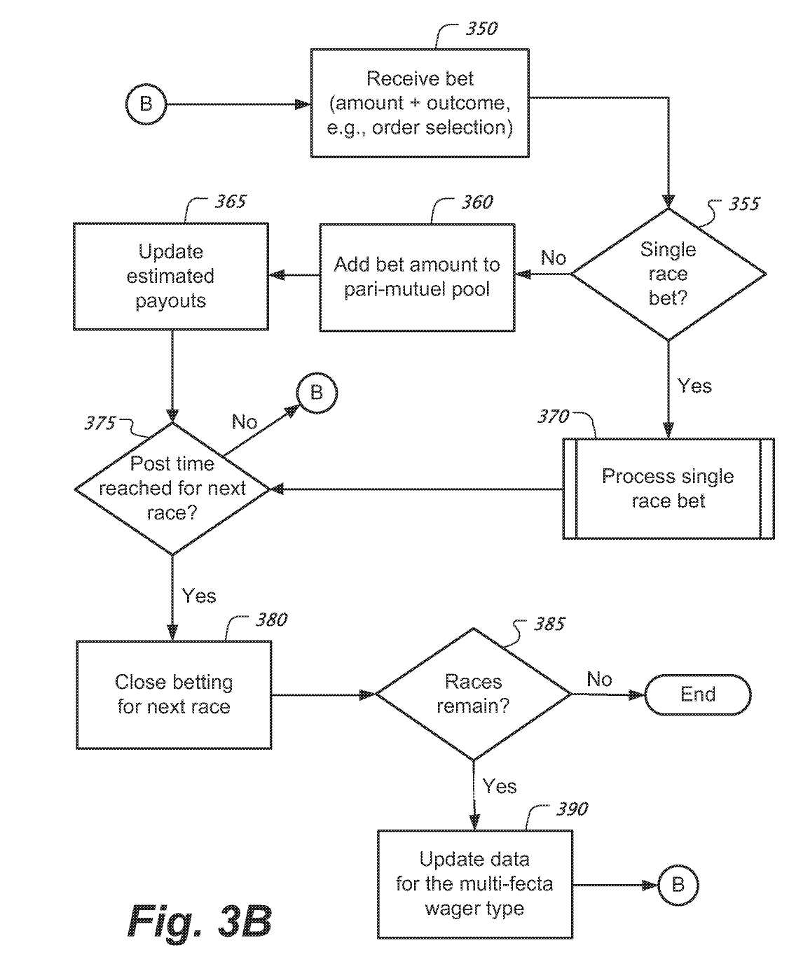

FIGS. 3A & 3B show another example of a method of creating and handling a pari-mutuel wager. Referring to FIG. 3A, odds data for a race is received at 305. In some implementations, the odds data is based on initial bets (of traditional bet types) made on the race well before the race is scheduled to begin. At 310, evenly matched racers are identified for the race based on the odds data. This can include removing a stand out favorite, as well as other racers with odds substantially different from remaining racers, to make a reduced field.

At 315, a check is made to see if the reduced field is viable. In some implementations, the bet type will require a minimum number of racers available for selection in each race. Thus, if the result of removing standouts to create an evenly matched field results in fewer racers than this minimum, the reduced field is not viable. In this case, the current race is skipped at 320. If the reduced field is viable, the identified racer outliers are removed at 325 to form an official reduced field for this race.

At 330, a check is made as to whether there are other races left to consider. If so, the method returns to 305 to receive odds data for the next race. For example, the set of races being processed to create a new bet can be races scheduled for a given track on a given day. In this case, each of the scheduled races on that track can be processed in turn. Once all the races in the set of races under current consideration have been processed, a check is made at 335 regarding whether a sufficient number of races have been identified as having a viable reduced field.

In some implementations, the bet type will require a minimum number of races (e.g., 3, 4, 5, or 6 races). If not enough races from the set are viable, then the new bet cannot be created. FIG. 3A shows the process ending at this point. However, in some implementations, the process can proceed by adding additional races to the set for consideration. For example, if the races scheduled for a given track on a given day cannot provide a sufficient number of viable races to create the new bet type, then races from one or more other tracks on the same day can be added to the set for consideration. Note that such other races can also have been included in the set of races under consideration from the beginning of the process. Moreover, since the races used to form this wager type can be held at multiple different locations across a country, the wager can be offered multiple times on the same day, which can further increase handle.

Once a sufficient number of races are identified to form the bet type, the resulting data for these identified races can be provided at 340 for use in receiving bets and handling payouts. As noted above, the bet type thus created can involve selection of three or four horses in each of multiple races. Thus, the bet type can be considered similar to multiple Trifectas, or multiple Superfectas, and may be referred to as a “multi-fecta” wager.

Referring to FIG. 3B, a bet is received at 350. As discussed above, each bet can include a bet amount and a wagered outcome (e.g., a selected order of four horses in each of multiple races) and can be received through a wagering terminal, and “multi-fecta” wagers can be received through a same interface device used by the system to receive traditional wagers types. At 355, a check is made as to whether the received bet is for a single race. In this example of some implementations, such single race bets are traditional bets that can be processed at 370 using traditional techniques.

If the received bet spans multiple races, the bet amount is added a pari-mutuel pool at 360, which is separate from the pari-mutuel pool(s) provided for the traditional bets that are received. In addition, the estimated payouts are updated at 365 based on the newly received and added bet. At 375, a check is made regarding whether the post time for the next race has been reached. If not, the method returns to 350 to receive a next bet. If so, betting for the next race is closed at 380.

At 385, a check is made regarding whether additional races remain. If not, the method ends. If so, data for the “multi-fecta” wager type can be updated at 390. Note that in some implementations, more races are available for selection by a bettor than need to be selected to form a “multi-fecta” wager. For example, the wager may be selection of four horses in each of four races, but there may be six different races on the schedule from which the bettor may select to form his specific wager. Thus, even though betting has closed for one race, the “multi-fecta” wager type may still be available if a sufficient number of races remain for selection.

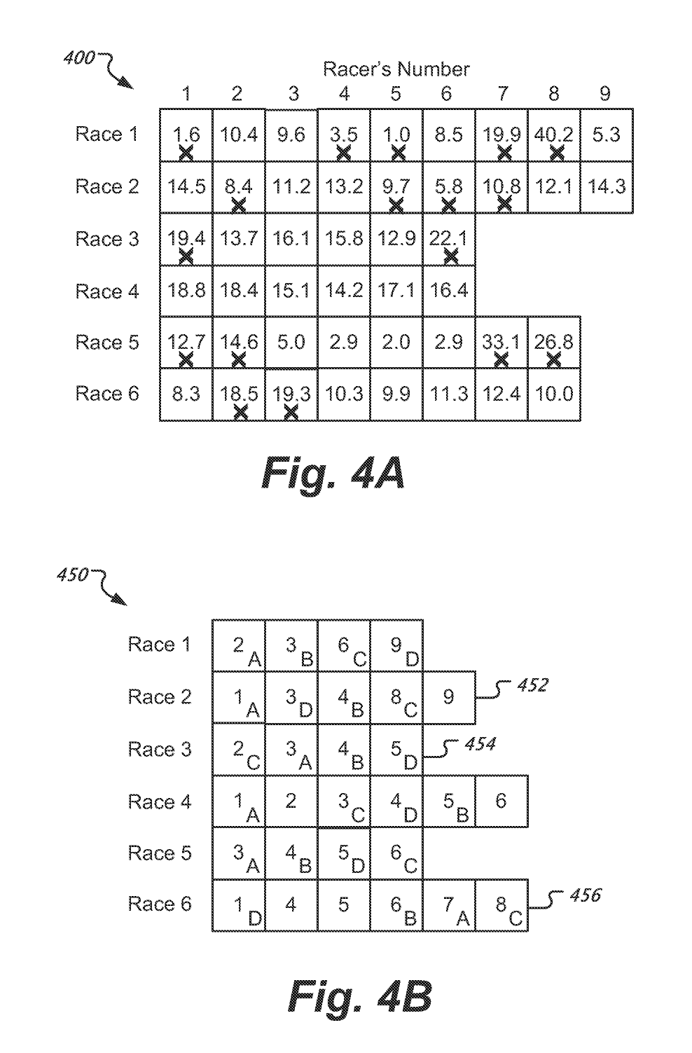

FIGS. 4A & 4B show an example of creating a pari-mutuel wager structure. In FIG. 4A, a schedule 400 shows six races to be run on a track in a given day. For each race, the odds of each racer winning the race are shown under that racer's number. Thus, in a horse race example, the odds of the number 3 horse winning Race 2 are 11.2%. The general identifiers for the racers (e.g., horse names) are not shown. Also, note that the same race participant can compete in more than one race, e.g., a specific horse can be the number 1 horse in Race 1 and also be the number 4 horse in Race 5.

In each race, the most evenly matched race participants are selected for the wager type. Thus, in Race 1, the stand-out favorite (#8) is removed, as indicated by the X in the figure, and the stand-out runner up (#7) can also be removed. Moreover, outliers on the long odds of the spectrum can also be removed. Thus, #1, #4, and #5 can also be removed from Race 1, as shown in FIG. 4A. This leaves four evenly matched racers (#2, #3, #6, and #9) from the field of nine for which a bettor can select a finishing order in Race 1.

FIG. 4A shows an example of which racers are removed for the six races using an X for each removed participant. In some cases, one or more favorites (e.g., #1 in race 2) need not be removed when the odds are such that keeping these participants in the field within the field make the resulting set of racers more evenly matched. Additionally, the field within a field can be larger than the number of horses to be selected for a particular bet. For example, Races 2, 4, and 6 in a horse race example have more than four horses to choose from when selecting a finishing order for four horses. In some implementations, some of the races used to form the multi-race bet need not have any racers removed (e.g., Race 4 in this example is a an evenly matched field from the start). In some implementations, the number of participants available for selection in a bet is reduced to the same number of participants to be selected in the bet (e.g., one more horse can be removed from Race 2, and two more horses can be removed from each of Races 4 and 6, when a finishing order of four horses are to be selected for the bet).

In the example shown in FIG. 4A though, some of the races provide the bettor with more available race participants from which to choose than needed to form his bet. Thus, as shown in FIG. 4B, the bettor chooses race participants in some races in addition to choosing a finishing order. FIG. 4B shows a selected bet 450 from the created bet type (where the removed racers' numbers are excluded from possible selection). The finishing order selected by the bettor in each race is shown using the letters A, B, C and D. Thus, in a horse race example, the bettor in this case has selected in Race 1 the number 2 horse to finish first among the available four horses, the number 3 horse to finish second among the available four horses, the number 6 horse to finish third among the available four horses, and the number 9 horse to finish fourth among the available four horses. Likewise, the bettor in this case has selected in Race 2 the number 1 horse to finish first among a selected set of four horses, the number 4 horse to finish second among the selected set of four horses, the number 8 horse to finish third among the selected set of four horses, and the number 3 horse to finish fourth among the selected set of four horses.

In this example, the bettor has selected four horses in each of the available races (six races in this case). However, in some implementations, the bettor can also select races when the number of races needed to form the bet is fewer than the number of available races from which the bet may be formed. For example, in some implementations, only three races are needed to form the bet, and so the bet may consist of race selections 452, 454, and 456.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method of supporting a wager type for a pari-mutuel betting race having a predetermined number of participants, the method comprising:
receiving odds data for each of the predetermined number of participants in the race;
removing, from the predetermined number of participants, one or more favorites to win the race based on the odds data, thereby forming a reduced field of participants for consideration in the race; and
providing the reduced field of participants to a totalizer system for use in calculating a pari-mutuel payout for a wager of the wager type based on the reduced field of participants and an outcome of the race once run with the one or more favorites, while ignoring the one or more favorites for purposes of the wager type.

2. The method of claim 1, wherein the race comprises two or more pari-mutuel betting races, the receiving comprises receiving participant odds data for each of the races, the removing comprises removing one or more favorites from each of the races to form a reduced field from each of the races, and the providing comprises providing the reduced fields for the races to the totalizer system for use in calculating the pari-mutuel payout for the wager of the wager type, wherein the wager type includes a selection for each of the races.

3. The method of claim 2, comprising identifying evenly matched participants in each of the races to form the respective reduced fields for the races.

4. The method of claim 2, wherein the selection for each of the races comprises a finishing order of participants from the reduced field.

5. The method of claim 4, wherein the selection for each of the races comprises a finishing order of all participants from the reduced field.

6. The method of claim 5, wherein the reduced field for each of the races has four participants total.

7. A system comprising:
a database system configured to store wager information for pari-mutuel betting on races, including a reduced field bet; and
a totalizer system coupled with the database system to access the wager information and configured to perform pari-mutuel payout calculations for at least one of the races, and the totalizer system configured to perform additional pari-mutuel payout calculations for the same at least one of the races while treating one or more race participants as non-existent in accordance with the reduced field.

8. The system of claim 7, comprising a computer programmed to identify evenly matched participants in each of the races to form the reduced field bet.

9. The system of claim 7, wherein the reduced field bet comprises a finishing order of participants from the reduced field.

10. The system of claim 9, wherein the reduced field bet comprises a finishing order of all participants from the reduced field.

11. The system of claim 10, wherein the reduced field for each of the races has four participants total.

12. A computer-implemented method comprising:
receiving multiple bets at a computer system, each of the bets being one of at least two types, the bet types comprising a first bet type corresponding to a single race, and a second bet type corresponding to two or more races, which include the single race,
wherein each of the bets comprise a bet amount and a wagered outcome,
wherein the wagered outcome for a bet of the first bet type comprises a win, place or show for a specific participant in the single race, and
wherein the wagered outcome for a bet of the second bet type comprises (i) a specific ordering of three or more participants in the single race, excluding at least the specific participant of the bet of the first bet type from consideration, and (ii) a specific ordering of three or more participants in each remaining race of the two or more races, excluding at least one participant from consideration in each remaining race of the two or more races;
combining, at the computer system, bet amounts to form a betting pool;
determining, at the computer system, a payout for the bet of the first bet type after the single race is run; and
determining, at the computer system, a payout for the bet of the second bet type, in part by ignoring the excluded participants, after the two or more races are run.

13. The computer-implemented method of claim 12, wherein the excluded participants are unevenly matched compared with other participants in the races.

14. The computer-implemented method of claim 12, wherein the specific ordering of three or more participants in the single race is a specific ordering of exactly four participants in the single race, and the specific ordering of three or more participants in each remaining race of the two or more races is a specific ordering of exactly four participants in each remaining race of the two or more races.
